(19) United States
(12) Patent Application Publication
(10) Pub. No.: US 2008/0316748 A1
(43) Pub. Date: Dec. 25, 2008

(54) ILLUMINATION SYSTEM

(75) Inventor: Raphael Egger, Munich (DE)

Correspondence Address: FISH & RICHARDSON PC, P.O. BOX 1022, MINNEAPOLIS, MN, 55440-1022, US

(73) Assignee: CARL ZEISS LASER OPTICS GmbH, Oberkochen (DE)

(21) Appl. No.: 11/766,334

(22) Filed: Jun. 21, 2007

(51) Int. Cl. F21V 13/00

(52) U.S. Cl. 362/293

(57) ABSTRACT

Illumination systems and related components and methods are disclosed.

### FIELD

The disclosure generally relates to illumination systems and related components and methods.

### BACKGROUND

Illumination systems that are capable of generating an illuminating line from a light beam are known.

### SUMMARY

The disclosure generally relates to illumination systems and related components and methods.

In some embodiments, an illumination system can generate an illuminating line in a field plane having an improved homogeneity (e.g., improved homogeneity along the long axis direction of the illuminating line).

A field plane is the plane onto which the illuminating line is directed. As an example, the field plane can be the position of the surface of a substrate onto which the illuminating line is focused.

In certain embodiments, an illumination system can be part of a laser annealing system. In such embodiments, the illuminating line can be used to anneal large substrates (e.g., the surface of these substrates).

In some embodiments, an illumination system can be part of scanning system. In such embodiments, the illuminating line can be scanned on the surface of a substrate.

In certain embodiments, an illumination system can include a filter unit. The filter unit can be capable of enhancing the edge sharpness and/or the homogeneity of the illuminating line. The filter unit may be designed such that thermal effects are negligible and/or such that the risk of deformation and/or destruction of optical elements and/or mounts is reduced significantly as compared to certain known systems.

In some embodiments, an illumination system (e.g., including a filter unit) can be part of a laser annealing system capable of annealing large substrates (e.g., the surface of these substrates).

In one aspect, the disclosure features an illumination system that includes an arrangement of optics and a filter unit. The arrangement of optics is capable of generating an illuminating line from an input light beam, where the illuminating line has a long axis and a short axis in a field plane. The arrangement of optics includes imaging and/or homogenizing optics configured so that during use the arrangement of optics separately images and/or homogenizes the input light beam in the directions of the long and short axes of the illuminating line. The filter unit is capable of correcting spatial uniformity in the long axis direction. The filter unit is remote to the field plane of the illuminating line or a plane optically conjugate thereof with respect to the short axis direction of the illuminating line.

In some embodiments, the system is configured so that during use an aspect ratio of the illuminating line exceeds a value of 10.

In certain embodiments, the system is configured so that during use the filter unit is in a pupil plane with respect to the short axis direction of the illuminating line. For example, the system can configured so that during use the filter unit is in a plane where expansion of the input light beam in the short axis direction of the illuminating line is larger than five times (e.g., larger than 10 times) expansion of the illuminating line in the short axis direction of the illuminating line in the field plane of the illuminating line or in a plane optically conjugate thereof closest to the filter unit. In some embodiments, taking into consideration typical beam widths of several micrometers, field related effects may mainly be excluded if the filter is positioned at a distance where the expansion of the beam in short axis direction exceeds 750 μm.

In some embodiments, the filter unit is located in a pupil plane with respect to the short axis direction. In general, the Fourier plane of the field plane is called a pupil plane. In the present case, the wording “pupil plane” shall not only cover the Fourier plane but also planes between the Fourier plane and the field plane provided that field dependent effects are negligible.

In some embodiments, the system is configured so that during use the filter unit is in a Fourier plane with respect to the short axis direction of the illuminating line.

In certain embodiments, the system is configured so that during use the filter unit is in or is close to the field plane of the illuminating line or an optically conjugate plane thereof with respect to the long axis direction of the illuminating line.

In some embodiments, the filter unit includes a transmission reducing element capable of at least locally reducing the transmission of the light beam. As an example, the transmission reducing element can include a beam absorbing element, a beam reflecting element, and/or a refractive beam deflecting element.

In certain embodiments, the system is configured so that during use the filter unit comprises a plurality of filter segments arranged adjacent to each other in the long axis direction of the illuminating line. For example, the system can arranged so that during use each of the filter segments is positioned in the short axis direction of the illuminating line anywhere between a position where it is out of the path of the light beam to where it extends a part of (e.g., less than 20% of, less than 10% of, less than 5% of, less than 2% of) the full way across a cross-section of the light beam.

In some embodiments, the filter unit includes a deflecting element configured so that during use the reflective element is capable of deflecting an unwanted portion of the input light beam directly or indirectly to a light dump, and the deflecting element includes a reflective beam deflecting element or a refractive beam deflecting element. For example, the deflecting element can include a refractive beam deflecting element that includes at least one wedge, and/or a refractive beam deflecting element that includes at least one cylindrical lens.

The system can be, for example, a laser annealing apparatus and/or a scanning system.

In another aspect, the invention features an illumination system that includes an arrangement of optics and a filter unit. The arrangement of optics is capable of generating an illuminating line from an input light beam, where the illuminating line has a long axis and a short axis in a field plane. The arrangement of optics includes imaging and/or homogenizing optics configured so that during use the arrangement of optics separately images and/or homogenizes the input light beam in the directions of the long and short axes of the illuminating line. The filter unit is capable of correcting spatial uniformity in the long axis direction of the illuminating line. The filter unit includes a refractive beam deflecting element capable of deflecting undesired portions of the input light beam directly or indirectly to a beam dump.

In some embodiments, the system is configured so that during use an aspect ratio of the illuminating line exceeds a value of 10 (e.g., exceeds a value of 50, exceeds a value of 1000, exceeds a value of 30000).

In certain embodiments, the refractive beam deflecting element includes at least one wedge. For example, the refractive beam deflecting element can include at least one cylindrical lens.

In some embodiments, the system includes a focusing cylindrical lens element arranged so that during use the focusing cylindrical lens unit is in the beam path behind the refractive beam deflecting optical element.

The system can be, for example, a laser annealing apparatus, and/or a scanning system.

In some embodiments, the system is a scanning system in which the illuminating line is scanned relative to the substrate in short axis direction. Thus, the illuminating line may travel in short axis direction over the substrate and/or the substrate may be moved in short axis direction such that sequentially one part after the other of the substrate is exposed to the illuminating line.

In the ideal case, the filter unit is precisely in a Fourier plane with respect to the short axis direction. Filtering of the beam in this plane has no influence on the size of the beam in the field plane or a plane conjugate thereof but only on the intensity profile in this plane(s).

In general the location of the filter unit with respect to the other direction, namely the long axis direction, does not have a significant effect with respect to the beam profile of the illuminating line in the (intermediate) field plane with respect to the short axis direction. In some embodiments, the filter unit is in or close to the field plane or an optically conjugate plane thereof with respect to the long axis direction. The filter may then be used for uniformity correction in long axis direction.

The filter unit may be a beam reflecting element such as, for example, a reflecting stop. Furthermore, the filter unit may be an absorber. Nevertheless, in certain embodiments, the filter unit includes a transmission reducing element in the form of a beam refractive deflecting element. In other words, instead of reflecting or absorbing the incoming beam the incoming beam may be refracted and deflected in another direction via an optically refractive element.

In some embodiments, the filter unit includes a plurality of filter segments being arranged side-by-side and/or adjacent to each other. The filter segments can be fingers which are arranged accordingly. The fingers may be arranged in one set or in two sets which, for example, face each other. Each set is arranged along the elongate beam direction. The fingers may locally be fixed (e.g., when installing the filter unit for the first time) or independently moveable in a direction perpendicular to the elongate beam direction (in the movement direction).

Each of the filter segments may be positioned anywhere between a position where it is out of the path of the beam or where it extends a part of the full way across the beam cross-section. The dipping depth into the beam can be such that an expected non-uniformity will be corrected.

In some embodiments, each of the filter segments is positioned anywhere between a position where it is out of the path of the beam or where it extends less than 15% of the full way across the beam cross-section. 15% may be an upper limit since known homogenizers such as fly's eye homogenizers or rods perform a non-uniformity correction well above the value.

In certain embodiments therefore each of the filter segments is positioned anywhere between a position where it is out of the path of the beam or where it extends less than 10% of the full way across the beam cross-section. A maximum 10% dipping depth in general is sufficient.

In some embodiments, each of the filter segments is positioned anywhere between a position where it is out of the path of the beam or where it extends less than 5% of the full way across the beam cross-section.

In some embodiments, when each of the filter segments is positioned anywhere between a position where it is out of the path of the beam or where it extends less than 2% of the full way across the beam cross-section filter dependent aberrations may not be detectable any more.

In certain embodiments, the filter unit includes a refractive beam deflecting element deflecting undesired parts of the input light beam directly or indirectly to a beam dump. For low power systems, this can be as simple as a piece of black velvet glued onto a stiff backing, but higher power beam dumps must often be designed carefully to avoid back-reflection, overheating, or excessive noise. Extremely high-power beam dumps have been made using water with controlled amounts of colored salts (e.g., copper (II) sulfate) to give a moderate absorbance of the beam. The water is circulated through a long pipe with a window at one end, and chilled using a heat exchanger.

The refractive beam deflecting element may include a wedge or a plurality of wedges being arranged side-by-side and adjacent one another, respectively. Wedges are quite simple optical elements and therefore may be fabricated low-priced.

The refractive beam deflecting element may (alternatively) include a cylindrical lens or a plurality of cylindrical lenses being arranged side-by-side and adjacent one another, respectively. Such a solution may be more expensive but on the other hand includes beam focusing functionalities which may simplify the direction of the filtered beam to the beam dump.

The filter unit additionally may include a field definition element whereto the deflected undesired parts of the input light beam are directed and which further directs the deflected undesired parts of the input light beam to the beam dump.

The field definition element may include in a very simple configuration a rod or a prism. Instead of this also an absorber or a mirror may be used.

Furthermore, the filter unit may include a focusing cylindrical lens element being arranged in the beam path behind the refractive beam deflecting optical element for focusing the deflected undesired parts of the input light beam. The beam focusing cylindrical element in some system configurations is necessary in order to direct the filtered beam in a very narrow space to the beam dump.

In some embodiments, the configuration of the system can reduce thermal effects in the beam delivery unit or the homogenizer or in general in the system. This filter unit (e.g. a blade) can be used for clipping the beam in the pupil plane or close to the field plane. If the clipping is done in the pupil plane of a predetermined direction, parts of the beam can be clipped without introducing field depending effects.

If the clipping is done close to a field plane (in the sense described above) a uniformity correction with a multiple number of refractive beam deflecting elements can be achieved.

Typically, the refractive beam deflecting element(s) are used only to deflect the beam and not to block it. At another position of the system a beam separating element may direct the beam into a beam dump. An advantage to such a configuration can be that there is no heating at the plane where energy should be clipped. Several beam deflecting refractive elements can be placed at different planes of the system. The (residual) energy will always be eliminated at the beam dump.

The refractive beam deflecting element may include a wedge or a plurality of wedges being arranged side-by-side and adjacent one another in the direction of the long axis. Additionally or alternatively the refractive beam deflecting element may include a cylindrical lens or a plurality of cylindrical lenses being arranged side-by-side and adjacent one another in the direction of the long axis.

The filter unit may cooperate with a field definition element whereto the deflected undesired parts of the input light beam are directed and which further directs the deflected undesired parts of the input light beam to the beam dump. The field definition element may include or consist of a rod or a prism.

The filter unit may include a focusing cylindrical lens element being arranged in the beam path behind the refractive beam deflecting optical element for focusing the deflected undesired parts of the input light beam.

The systems can be used, for example, in annealing large substrates, in the field of laser induced crystallization of substrates, in the field of flat panel display (e.g., organic light emitting diode (OLED) display, thin film transistor display manufacturing processes) and solar cell technology (e.g. polycrystalline thin film solar cell processing technology).

### BRIEF DESCRIPTION OF THE DRAWINGS

The disclosure will be described further, by manner of example, with reference to the accompanying drawings, in which:

FIG. 1 shows a cross section in the xz-plane of a Cartesian coordinate system of an embodiment of an optical illumination system according to the disclosure for generating a sharp illuminating line on a panel; the diagrammatic presentation illustrates the beam path for generating the so-called long beam axis of the illuminating line;

FIG. 2 shows a cross section in the yz-plane of a Cartesian coordinate system of the first embodiment of an optical illumination system according to FIG. 1; the diagrammatic presentation illustrates the beam path for generating the so-called short beam axis of the illuminating line;

FIG. 3 is a cut along X1-X1 of the optical illumination system according to FIGS. 1 and 2 showing filters according to the disclosure;

FIG. 4 is a cut through the intensity distribution of the illuminating line in the long axis direction produced by the optical illumination system at position X2-X2 (intermediate field plane in short axis direction) without using any filters according to FIG. 3 (straight line) and with filters according to FIG. 3 (dashed line);

FIG. 5 is a cut through the intensity distribution of the illuminating line in the long axis direction produced by the optical illumination system at position X3-X3 (field plane in long and short axis direction, panel plane) without using any filters according to FIG. 3 (straight line) and with filters according to FIG. 3 (dashed line);

FIG. 6 is a cut through the intensity distribution of the illuminating line in the short axis direction produced by the optical illumination system at position Y2-Y2 (intermediate field plane in short axis direction) without using any filters according to FIG. 3 (straight line) and with filters according to FIG. 3 (dashed line);

FIG. 7 is a cut through the intensity distribution of the illuminating line in the short axis direction produced by the optical illumination system at position Y3-Y3 (field plane in long and short axis direction, panel plane) without using any filters according to FIG. 3 (straight line) and with filters according to FIG. 3 (dashed line);

FIG. 8 shows a cross section in the xz-plane of a Cartesian coordinate system of a second embodiment of an optical illumination system according to the disclosure for generating a sharp illuminating line on a panel; the diagrammatic presentation illustrates the beam path for generating the so-called long beam axis of the illuminating line;

FIG. 9 shows a cross section in the yz-plane of a Cartesian coordinate system of the second embodiment of an optical illumination system according to FIG. 8; the diagrammatic presentation illustrates the beam path for generating the so-called short beam axis of the illuminating line;

FIG. 10 shows a cross section in the yz-plane of a Cartesian coordinate system of a section of a third embodiment of an optical illumination system according to the disclosure for generating a sharp illuminating line on a panel; the diagrammatic presentation illustrates the beam path for generating the so-called short beam axis of the illuminating line;

FIG. 11 is a cut along X1b-X1b of the optical illumination system according to FIG. 10 showing filters according to the disclosure;

FIG. 12 is a cut through the intensity distribution of the illuminating line in the long axis direction produced by the optical illumination system at position X3-X3 (field plane in long and short axis direction, panel plane) without using any filters according to FIG. 11 (straight line) and with filters according to FIG. 11 (dashed line);

FIG. 13 shows a cross section in the xz-plane of a Cartesian coordinate system of a fourth embodiment of an optical illumination system according to the disclosure for generating a sharp illuminating line on a panel; the diagrammatic presentation illustrates the beam path for generating the so-called long beam axis of the illuminating line.

### DETAILED DESCRIPTION

The disclosure will be described via embodiments shown in the drawings. Although the embodiments shown in the drawings are based on lenses or dioptric optical elements, catadioptric or mirror arrangements may be used.

In general, the embodiments are anamorphic optical arrangements used for laser annealing of large substrates as outlined in the introduction part of the application. An anamorphic image is an optical image of which the imaging scale or image size differs in two sections (directions) which are at right angles to each other. As an example, the two mutually perpendicular sections can lie in the directions of the long and short axes, respectively, of the elongated illuminating line. In other words, anamorphic separation of the image and homogenization of the input light beam (e.g., a laser beam) in these two mutually perpendicular directions is provided.

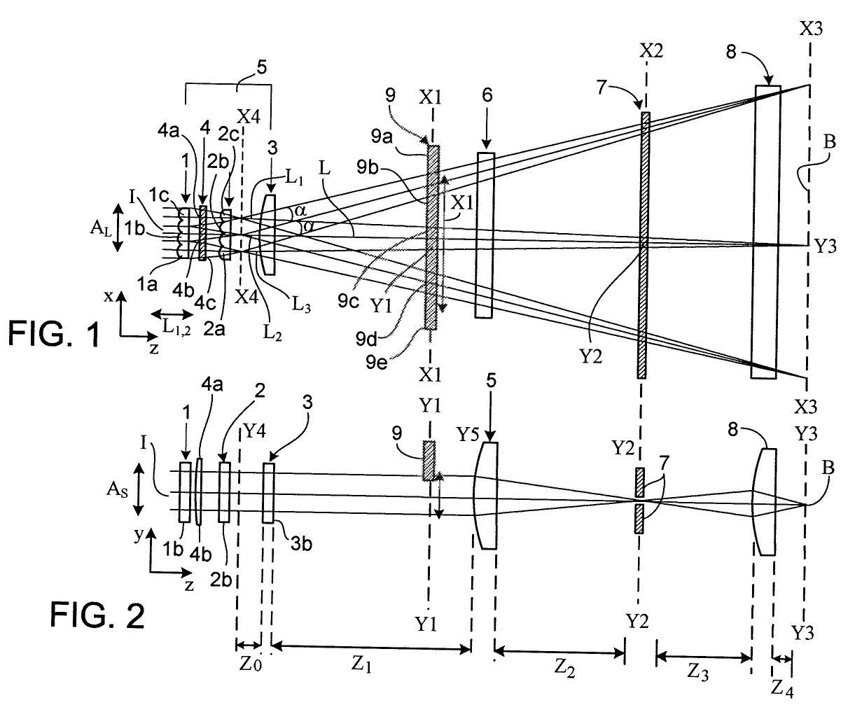

FIGS. 1 and 2 depict a system including a light source (not shown) such as for example an excimer laser, a solid state laser or similar. The light source emits a beam (e.g., a pulsed beam) in the following named as input light beam I. The dimensions of the input light beam I, if an Excimer laser as a light source for instance is used, may be 20 mm×15 mm. The wavelength of the input light beam may be for example 351 nm.

This laser beam I is to be processed via the optics which will be specified below to yield an illuminating line B (right hand part in FIGS. 1 and 2).

The optical system according to FIGS. 1 and 2, on the whole, is an anamorphic system in the sense that the processing of the input light beam I in different axis being perpendicular to each other takes place largely independently. This is mainly achieved by using cylindrical optics being optically active only in one direction whereby the cylindrical optics for different axis are arranged transverse or perpendicular to each other. Since the expansion of the illuminating line B in one direction exceeds the dimension in the other direction by a multiple, the first one is called the long axis direction A₁ and the latter one is called the short axis direction Aₛ. The illuminating line B in general may be a linear line with an expansion in short axis direction Aₛ of e.g. 5 to 10 μm and in long axis direction of e.g. 500 to 1000 mm or more.

The input light beam I propagating in z-direction first passes a homogenizer which homogenizes the input light beam I in both, the short and long axis directions Aₛ,A₁. The homogenizer 5 for the long axis direction A₁ is built of two cylindrical lens arrays 1, 2 and a cylindrical condenser lens 3. The cylindrical lens arrays 1, 2 include a plurality of cylindrical lenses 1a, 1b, 1c, 2a, 2b, 2c being arranged adjacent to each other. In the present case three lenses 1a, 1b, 1c, 2a, 2b, 2c of each cylindrical lens array 1, 2 are drawn. In general each cylindrical lens array 1, 2 may include e.g. ten individual lenses 1a, 1b, 1c, 2a, 2b, 2c with diameters of 2 mm and lengths of 30 mm. The cylindrical condenser lens 3 may have a size of several times the expansions of the cylindrical lens arrays 1, 2.

The cylindrical lenses 1a, 1b, 1c, 2a, 2b, 2c and the cylindrical condenser lens 3 are curved in x-direction, only, thus being optically active in the x-direction, only. A cylindrical field lens 1a, 1b, 1c of the first cylindrical lens array 1 and a cylindrical pupil lens 2a, 2b, 2c of the second cylindrical lens array 2 being arranged in a distance corresponding to the focal lengths f_{1, 2} (which might be several Millimetres) of the respective cylindrical field/pupil lenses 1a, 1b, 1c, 2a, 2b, 2c each forming a light channel. The condenser lens 3 images each light channel to the field plane X3 where a substrate, a glass plate covered with a thin amorphous Silicon layer for instance, may be arranged. The angular distribution of the arrays 1, 2 thereby is transformed to a field distribution in the substrate plane X3. The size of the field (e.g. the size of the illuminating line B) depends on the focal length f₃ (which might be 2000 mm) of the condenser lens 3 and the maximum angle α (which might be around 11 degrees) of the arrays 1, 2. Instead of a homogenizer 5 described above also any other homogenizer may be used such as for example disclosed in DE 42 20 705 A1, DE 38 29 728 A1, DE 38 41 045 A1, JP 2001156016 A1 or US 2006/0209310 A1.

Despite similar homogenization concepts might be used also in order to homogenize the input light beam I in y-direction the first embodiment shown in FIGS. 1 and 2 bases on another possible homogenization scheme for the short axis Aₛ, namely the so called sliced lens concept being already described in US 2006/0209310 A1. In the case shown in FIGS. 1 and 2 a segmented (sliced) cylindrical lens 4 is arranged between the two cylindrical lens arrays 1, 2. The cylindrical lens 4 with curvature in y-direction consists of a plurality of individual lens segments 4a, 4b, 4c. In the present case the number of cylindrical lens segments 4a, 4b, 4c coincides with the number of individual cylindrical field lenses 1a, 1b, 1c and with the number of cylindrical pupil lenses 2a, 2b, 2c.

The size of the cylindrical lens segments 4a, 4b, 4c in direction to the long axis A₁ is equivalent to the size of one of the cylindrical lenses 1a, 1b, 1c, 2a, 2b, 2c of each lens array 1, 2. Each cylindrical lens segment 4a, 4b, 4c, therefore, in x-direction is arranged in a light channel corresponding to a pair of cylindrical field/pupil lenses 1a, 1b, 1c, 2a, 2b, 2c as may be best seen from FIG. 1. The individual cylindrical lens segments 4a, 4b, 4c with curvatures in short axis direction Aₛ are displaced (and for example mechanically movable) independently in direction to the short axis direction Aₛ as may be seen from FIG. 2. The main beam 13 in short axis direction Aₛ is deflected depending on the amount of relative displacement.

In the focal plane Y2 of the cylindrical condenser lens 6 the width (in short axis direction Aₛ) of a sub-beam L₁, L₂, L₃ depends on its divergence in the short axis direction Aₛ. Assuming a typical beam divergence of 300 μrad the width of each sub-beam L₁, L₂, L₃ is 150 μm. Because of overlapping several of these sub-beams L₁, L₂, L₃ displaced by each other a homogenized beam L can be generated as is described in detail in US 2006/0209310 A1.

At the position Y2 of the focused beam L in the short axis direction Aₛ a field defining element 7 can be placed. This possibility is also shown in FIG. 2. A projection optics 8 being arranged in the optical path behind the field defining element 7 images the field defining element 7 onto the plane Y3 of the substrate. The projection optics 5 shown in FIG. 2 is a projection cylindrical lens 8 which images only in direction to the short axis Aₛ. Instead of the projection cylindrical lens 8 also a cylindrical mirror may be used. A beam profile in the short axis direction Aₛ the (intermediate field plane Y2) in front of the field defining element 7 as shown as a dashed line in FIG. 6 is imaged into the field plane Y3 having the dashed line beam profile as shown in FIG. 7. Presently, a reduction scale of M=⅓ is used. For comparison reasons also the respective beam profiles for the optical system without filter 9 is drawn as straight lines.

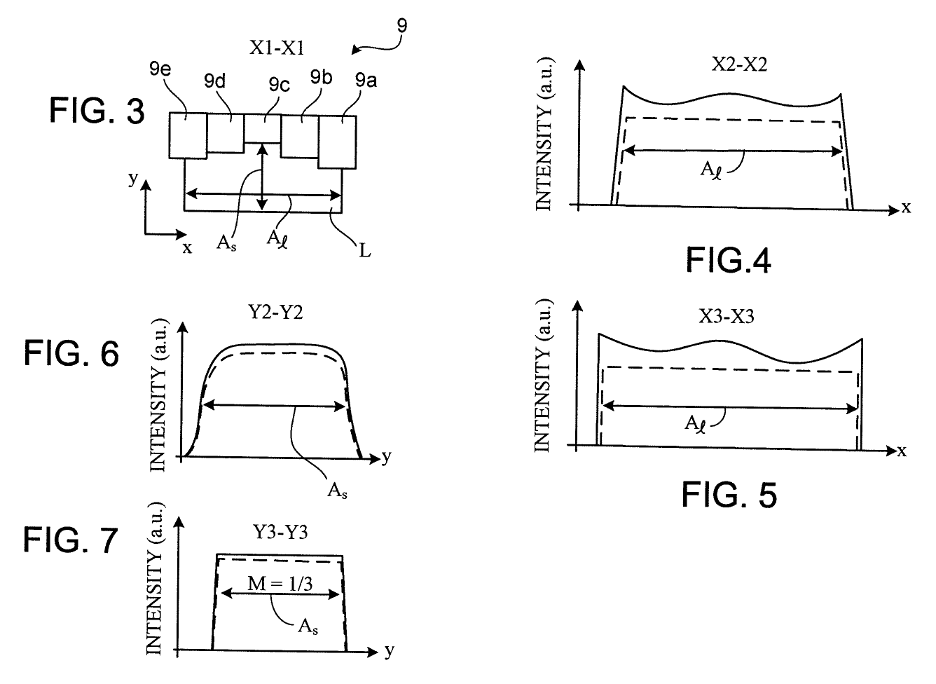

It has been found that depending on several edge conditions the intensity of the illuminating line B on the substrate may locally vary in the long axis direction A₁. For some manufacturing processes such variations may not be tolerable. According to the disclosure a non-uniformity correction device for correcting the intensity non-uniformity in the long axis direction has been provided. The intensity non-uniformity correction device consists of a filter 9 which blocks a part of the homogenized beam L in the short axis direction Aₛ. The filter 9 includes a plurality of filter segments 9a, 9b, 9c, 9d, 9e being arranged adjacent to each other and being capable of (at least partly) blocking along the long axis direction A₁ different amounts of the expansions of the beam L in short axis direction Aₛ. FIG. 3 shows such an intensity non-uniformity correction device (filter 9) comprising five filter segments 9a, 9b, 9c, 9d, 9e each having a rectangular shape. The five filter segments 9a, 9b, 9c, 9d, 9e are arranged side-by-side and adjacent to each other along the long axis direction A₁. Each filter segment 9a, 9b, 9c, 9d, 9e can (fixedly or movably) be positioned anywhere between a position where it is out of the light path or where it extends full way across the beam cross-section. Or in other words: Each filter segment 9a, 9b, 9c, 9d, 9e immerses unequally deep into the contour of the light beam L, therefore cutting different parts of the outer shape of the light beam L along the long axis direction A₁, thus, each filter segment 9a, 9b, 9c, 9d, 9e can be positioned so that an optimum transmission profile is achieved.

For non-uniformity correction of the light beam L in the long axis direction the filter 9 is introduced in a plane where the outer contour of the illuminating line B on the substrate (field) plane X3, Y3 is (essentially) not affected but only the intensity profile along the long axis direction A₁. Therefore, the filter 9 with its filter segments 9a, 9b, 9c, 9d, 9e may not be placed in the substrate plane Y3 with respect to the short axis direction Aₛ or a conjugate plane thereof such as the (intermediate) field plane Y2. The filter 9, or the filter segments 9a, 9b, 9c, 9d, 9e, respectively, may only be placed in a plane remote from the field plane Y3 with respect to the short axis direction Aₛ or a plane Y2 conjugate thereof, namely a pupil plane with respect to the short axis direction Aₛ where the local distribution of the illuminating line B in the field or substrate plane Y3 is transformed into an angular distribution α; or in other words: remote from a field plane Y3 or a plane Y2 conjugate thereof is a plane where field dependent effects may be neglected. In the present case the distance from a(n) (intermediate) field plane will be some Millimetres. In the ideal case the filter 9 is positioned in a Fourier plane with respect to the field plane Y3 in short axis direction Aₛ or a plane Y2 conjugate thereof. In this case the Fourier plane is in the regions z0, z1 between the positions indicated with reference signs Y4 and Y5.

In the systems depicted in FIGS. 1 and 2 the optimum position of the filter 9 (or the filter segments 9a, 9b, 9c, 9d, 9e, respectively) is in front of the cylindrical focusing lens 6 for the short axis Aₛ which is indicated by the region identified with reference number z1. As an example FIGS. 1 and 2 show the filter 9 of FIG. 3 being arranged quite close to the cylindrical focusing lens 6 for the short axis direction Aₛ.

The number of filter segments 9a, 9b, 9c, 9d, 9e in direction to the long axis A₁ determines the effectiveness of the uniformity control. The larger the number the better the correction can be. In principle the number of correction steps can be equal to the number of filter segments 9a, 9b, 9c, 9d, 9e. On the other hand there is a limitation which is due to the sub-aperture in the plane of the filter segments 9a, 9b, 9c, 9d, 9e. The sub-aperture x₁, y₁ at the plane X1, Y1 of the filter segments 9a, 9b, 9c, 9d, 9e is the cross section at this plane X1, Y1 for a bundle of all possible rays which are traced from a single field point at the panel plane X3, Y3 in direction to the arrays 1, 2. If the dimension of the filter 9 comprising the filter segments 9a, 9b, 9c, 9d, 9e in the long axis direction x is smaller then the sub-aperture x₁ at this plane X1, Y1 the number of correction steps is smaller than the number of filter segments 9a, 9b, 9c, 9d, 9e.

In the shown example in FIGS. 1 and 2 the size of the sub-aperture x1 is comparable to the size of the filter 9 in the long axis direction x. The drawing only shows five filter segments 9a, 9b, 9c, 9d, 9e. In order to have extended correction possibilities this number should be in the range of 10 to 100 or even larger. A filter segment 9a, 9b, 9c, 9d, 9e will not extend full way across the beam cross section but only less than 10% (e.g., less than 5%, less than 2%) of the full way across the beam cross-section in order not to significantly reduce focal depth of the illuminating line B in the substrate plane X3, Y3.

Adjusting the filter segments 9a, 9b, 9c, 9d, 9e with respect to each other and in particular with respect to the homogenized light beam L hitting the filter 9 a homogenization of the intensity profile along the long axis direction A₁ may be achieved as is outlined in the following by reference to FIGS. 4 and 5. FIG. 4 shows a cut through the intensity distribution of the illuminating line L in the long axis direction A₁ produced by the optical illumination system at position X2-X2 which is an intermediate field plane in short axis direction Aₛ without using any filters (straight line) and with filter 9 according to FIG. 3 (dashed line) for comparison. FIG. 5 shows a cut through the intensity distribution of the illuminating line B in the long axis direction A₁ produced by the optical illumination system at position X3-X3 which is a field plane in both long and short axis direction without using any filters (straight line) and with filter 9 according to FIG. 3 (dashed line) for comparison.

If the sub-aperture x₁ at the position in front of the focusing lens 6 is too large or if for other reasons a different location is required the filter 9 can be also placed behind the focusing lens 6 for the short axis direction Aₛ. The respective regions are indicated in FIG. 2 with reference numbers z2, z3 and z4. Only the regions quite close to the (intermediate) field planes Y2, Y3 with respect to the short axis direction Aₛ due to the dominance of field depending effects as well as the positions where other optical elements 3, 6, 7, 8 are already placed are excluded. The least distances with respect to the respective (intermediate) field planes Y2, Y3 are at the arrangement described above at least 500 μm.

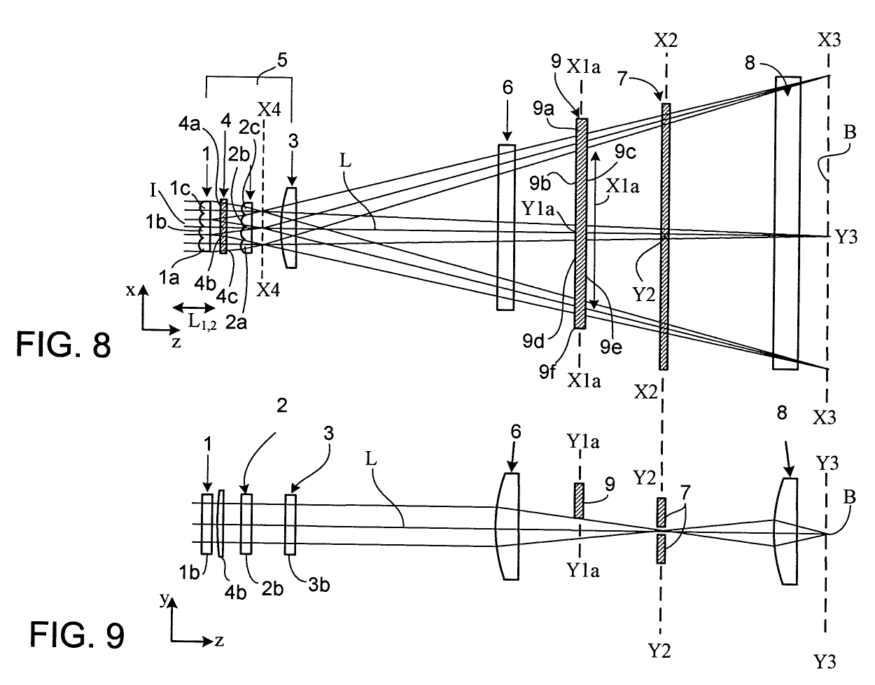

FIGS. 8 and 9 depict an optical system according which differs from that shown in FIGS. 1 and 2 only by that the filter 9 is arranged in region z2, i.e. behind the cylindrical focusing lens 6 for the short axis direction Aₛ. Only positions close to the field defining element 7 or the panel plane Y3 are (intermediate) field planes for the short axis Aₛ. As long as the cross section of the beam L is much larger than the cross section of the beam L at the planes Y2 or Y3 the reduction in transmission due to the filter 9 is equal all over the short axis profile in the planes Y2 and Y3. The following rule of thumb for the pupil plane in the short axis direction Aₛ may be used as a reference:

If for a plane between planes Y2 and Y3 the cross section of the light beam L in the short axis direction Aₛ is larger than five times the cross section of the light beam L in plane Y3 this plane may be called a pupil plane. If for a plane between the plane defined by the focusing cylindrical lens 4 and the plane Y2 defined by the field defining optical element 7 the cross section of the light beam L in the short axis direction Aₛ is larger than five times the cross section of the light beam L in the plane Y2 where the field defining optical element 7 is located this plane may be called a pupil plane. The same is valid between the planes Y2 and Y3. To be really field independent a factor larger than ten can be advantageous.

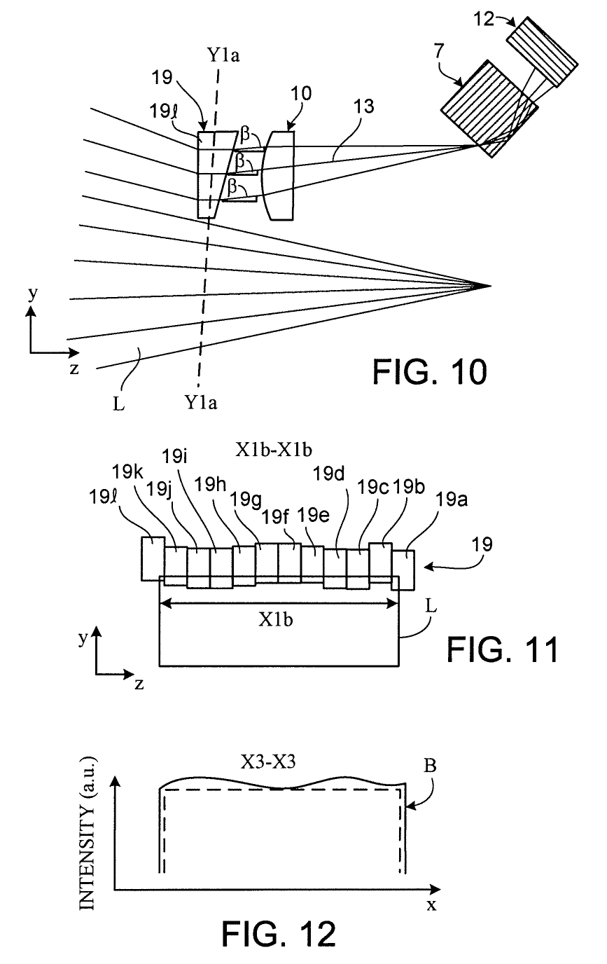

FIG. 10 shows a cross section in the yz-plane of a Cartesian coordinate system of a section of an embodiment of an optical illumination system. The diagrammatic presentation illustrates the beam path for generating the so-called short beam axis of the illuminating line. The optical illumination system as such is essentially identical with those shown in FIGS. 8, 9, respectively. The main difference consists in the mechanical construction of the filter which for distinguishable reasons is indicated with reference number 19. In the case shown in FIG. 10 filter 19 is located in region z2 drawn in FIG. 2.

While the filters 9 shown in FIGS. 1, 2 and 8, 9 may be light absorbing or light reflecting optical elements such as plane windows or mirrors in the present case another inventive concept for clipping the undesired parts of the light beam L is used. A solution for a controlled clipping of a beam L which has at least one direction y with a low etendue of the incoming (laser) beam I is presented. Instead of using an absorber, a blocking blade or a mirror a refractive beam deflecting element 19 consisting of a plurality of refractive beam deflecting segments 19a, . . . 19l as shown in FIG. 11 in combination with a focusing cylindrical lens 10 is used. The refractive beam deflecting element 19 deflects the unwanted parts of the light beam L in direction y. The deflecting angle β is chosen so that the deflected beam L hits completely the field defining element 7. At the position of the field defining element 7 the beam L is directed into a beam dump 12.

The refractive beam deflecting element 19 can be a wedge (as is shown in FIG. 10) or also a cylindrical lens which is shifted in direction to the axis y. The curvature of this lens should be small in order to avoid defocusing effects. The field defining optical element 7 presently is a rod with squared cross section. Instead of a rod also a prism or a mirror may be used. Presently, for simplicity the cylindrical lens 10 is a single piece. The cylindrical lens may also be segmented as e.g. the wedge 19 (wedge segments 19a, . . . 19l).

For completeness FIG. 12 shows the intensity profile of the illuminating line B in plane X3 without (straight line) and with (dashed line) filter 19.

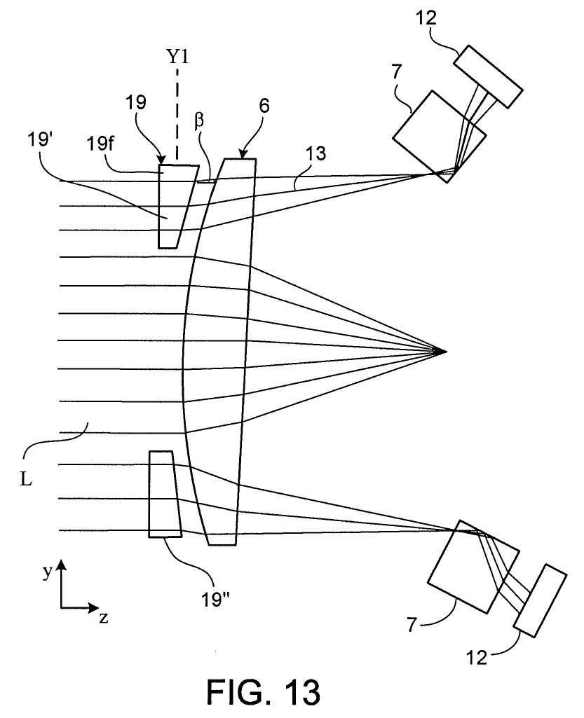

FIG. 13 shows a cross section in the yz-plane of a Cartesian coordinate system of a section of an embodiment of an optical illumination system according to the disclosure. The diagrammatic presentation illustrates the beam path for generating the so-called short beam axis of the illuminating line. The optical illumination system as such is essentially identical with that shown in FIGS. 1, 2, respectively. The main difference consists in the mechanical construction of the filter which for distinguishable reasons is again indicated with reference number 19. In the case shown in FIG. 13 filter 19 is located in region z1 drawn in FIG. 2.

FIG. 13 shows that the filter 19 includes two sub-filters 19′ and 19″ being capable of clipping the upper and lower parts of the light beam L in short axis direction Aₛ, or in other words the filter 9 includes two sets of sub-filters which face each other. In the present embodiment each refractive beam deflecting element 19′, 19″ is a wedge similar to that shown in FIG. 10 with a plurality of segments 19a, 19b, . . . 19f.

Different from the example of FIG. 10 as a focusing element the focusing cylindrical lens 6 is used. The focal plane of the focusing cylindrical lens 6 is located very close to the field defining optical element 7. The deflecting angle β of the main beam 13 between the refractive beam deflecting element 19′ and the focusing cylindrical lens 6 is transformed into height h=f₆*tan(β) at the rod 7, whereby f₆ is the focal length of the optical element 6. The light beam L hits the element 7 and is internally reflected in the element 7. After this the beam L is absorbed by the beam dump 12. Typical values for the focal length f₆ and the height h are f₆=500 mm, h=1 mm.

### REFERENCE SIGNS

1 first cylindrical lens array
1a, 1b, 1c cylindrical field lens
2 second cylindrical lens array
2a, 2b, 2c cylindrical pupil lens
3 condenser cylindrical lens
4 segmented cylindrical lens, homogenizer for short axis direction
4a, 4b, 4c cylindrical lens segment
5 homogenizer for long axis direction
6 cylindrical focusing lens for short axis direction
7 field defining element for short axis direction
8 projection cylindrical lens for short axis direction
9 filter
9a, 9f filter segment
10 focusing cylindrical lens element
12 beam dump
13 main beam
19 refractive beam deflecting element
19′ sub-filter
19″ sub-filter
19a, . . . 19l refractive beam deflecting segments
A₁ long axis direction
Aₛ short axis direction
B illuminating line
I input light beam
L homogenized light beam
L₁ sub-beam
L₂ sub-beam
L₃ sub-beam
X1 plane near field plane with respect to x-axis
X2 plane near field plane with respect to x-axis
X3 field plane with respect to x-axis
X4 Fourier plane with respect to x-axis
Y1 pupil plane with respect to y-axis
Y2 field plane with respect to y-axis
Y3 field plane with respect to y-axis
Y4 pupil plane with respect to y-axis
Y5 Fourier plane with respect to y-axis
f_{1,2} focal length of field/pupil lens
f₃ focal length of condenser lens
f₆ focal length of focusing cylindrical lens element
h height
x₁ sub-aperture at X1
x₁ₐ sub-aperture at X1a
x_{1b} sub-aperture at X1b
z0 possible location for filter
z1 possible location for filter
z2 possible location for filter
z3 possible location for filter
z4 possible location for filter
α angle
β deflecting angle
   Other embodiments are in the claims.

What is claimed is:

1. An illumination system, comprising:
an arrangement of optics capable of generating an illuminating line from an input light beam, the illuminating line having a long axis and a short axis in a field plane, the arrangement of optics including imaging and/or homogenizing optics configured so that during use the arrangement of optics separately images and/or homogenizes the input light beam in the directions of the long and short axes of the illuminating line, and
a filter unit capable of correcting spatial uniformity in the long axis direction,
wherein the filter unit is remote to the field plane of the illuminating line or a plane optically conjugate thereof with respect to the short axis direction of the illuminating line.

2. The illumination system according to claim 1, wherein the system is configured so that during use an aspect ratio of the illuminating line exceeds a value of 10.

3. The illumination system according to claim 1, wherein the system is configured so that during use the filter unit is in a pupil plane with respect to the short axis direction of the illuminating line.

4. The illumination system according to claim 3, wherein the system is configured so that during use the filter unit is in a plane where expansion of the input light beam in the short axis direction of the illuminating line is larger than five times expansion of the illuminating line in the short axis direction of the illuminating line in the field plane of the illuminating line or in a plane optically conjugate thereof closest to the filter unit.

5. The illumination system according to claim 3, wherein the system is configured so that during use the filter unit is in a plane where expansion of the input light beam in the short axis direction of the illuminating line is larger than ten times expansion of the illuminating line in the short axis direction of the illuminating line in the field plane of the illuminating line or in a plane optically conjugate thereof closest to the filter unit.

6. The illumination system according to claim 3, wherein the system is configured so that during use the filter unit is in a Fourier plane with respect to the short axis direction of the illuminating line.

7. The illumination system according to claim 1, wherein the system is configured so that during use the filter unit is in or is close to the field plane of the illuminating line or an optically conjugate plane thereof with respect to the long axis direction of the illuminating line.

8. The illumination system according to claim 1, wherein the filter unit comprises a transmission reducing element capable of at least locally reducing the transmission of the light beam.

9. The illumination system according to claim 8, wherein the transmission reducing element comprises a beam absorbing element.

10. The illumination system according to claim 8, wherein the transmission reducing element comprises a beam reflecting element.

11. The illumination system according to claim 8, wherein the transmission reducing element comprises a refractive beam deflecting element.

12. The illumination system according to claim 1, wherein the system is configured so that during use the filter unit comprises a plurality of filter segments arranged adjacent to each other in the long axis direction of the illuminating line.

13. The illumination system according to claim 12, wherein the system is arranged so that during use each of the filter segments is positioned in the short axis direction of the illuminating line anywhere between a position where it is out of the path of the light beam to where it extends a part of the full way across a cross-section of the light beam.

14. The illumination system according to claim 12, wherein the system is arranged so that each of the filter segments is positioned anywhere between a position where it is out of the path of the beam to where it extends less than 20% of the full way across a cross-section of the light beam.

15. The illumination system according to claim 12, wherein the system is arranged so that each of the filter segments is positioned anywhere between a position where it is out of the path of the beam to where it extends less than 10% of the full way across a cross-section of the light beam.

16. The illumination system according to claim 12, wherein the system is arranged so that each of the filter segments is positioned anywhere between a position where it is out of the path of the beam to where it extends less than 5% of the full way across a cross-section of the light beam.

17. The illumination system according to claim 12, wherein the system is arranged so that each of the filter segments is positioned anywhere between a position where it is out of the path of the beam to where it extends less than 2% of the full way across a cross-section of the light beam.

18. The illumination system according to claim 1, wherein the filter unit comprises a deflecting element configured so that during use the reflective element is capable of deflecting an unwanted portion of the input light beam directly or indirectly to a light dump, the deflecting element comprising a reflective beam deflecting element or a refractive beam deflecting element.

19. The illumination system according to claim 18, wherein the deflecting element comprises a refractive beam deflecting element that includes at least one wedge.

20. The illumination system according to claim 18, wherein the deflecting element comprises a refractive beam deflecting element that includes at least one cylindrical lens.

21. An apparatus, comprising:
an illumination system according to one of claim 1,
wherein the apparatus is a laser annealing apparatus.

22. A system, comprising:
an illumination system according to one of claim 1,
wherein the apparatus is a scanning system.

23. An illumination system, comprising:
an arrangement of optics capable of generating an illuminating line from an input light beam, the illuminating line having a long axis and a short axis in a field plane, the arrangement of optics including imaging and/or homogenizing optics configured so that during use the arrangement of optics separately images and/or homogenizes the input light beam in the directions of the long and short axes of the illuminating line, and
a filter unit capable of correcting spatial uniformity in the long axis direction of the illuminating line,
wherein the filter unit comprises a refractive beam deflecting element capable of deflecting undesired portions of the input light beam directly or indirectly to a beam dump.

24. The illumination system according to claim 23, wherein the system is configured so that during use an aspect ratio of the illuminating line exceeds a value of 10.

25. The illumination system according to claim 23, wherein the system is configured so that during use the aspect ratio of the illuminating line exceeds a value of 50.

26. The illumination system according to claim 23, wherein the system is configured so that an aspect ratio of the illuminating line exceeds a value of 1000.

27. The illumination system according to claim 23, wherein the system is configured so that during use an aspect ratio of the illuminating line exceeds a value of 30000.

28. The illumination system according to claim 23, wherein the refractive beam deflecting element comprises at least one wedge.

29. The illumination system according to claim 23, wherein the refractive beam deflecting element comprises at least one cylindrical lens.

30. The illumination system according to claim 23, wherein the filter unit comprises a focusing cylindrical lens element arranged so that during use the focusing cylindrical lens unit is in the beam path behind the refractive beam deflecting optical element.

31. An apparatus, comprising:
an illumination system according to one of claim 23,
wherein the apparatus is a laser annealing apparatus.

32. A system, comprising:
an illumination system according to one of claim 23,
wherein the apparatus is a scanning system.
